(19) United States
(12) Patent Application Publication
(10) Pub. No.: US 2013/0165204 A1
(43) Pub. Date: Jun. 27, 2013

(54) METHOD AND APPARATUS FOR PLAYING A GAME WITH MULTIDIMENSIONAL CARDS AND SCATTER REPLACEMENT FEATURE

(71) Applicant: Incredible Technologies, Inc., Vernon Hills, IL (US)

(72) Inventor: Leonid Smikun, Glenview, IL (US)

(73) Assignee: Incredible Technologies, Inc., Vernon Hills, IL (US)

(21) Appl. No.: 13/715,661

(22) Filed: Dec. 14, 2012

Related U.S. Application Data
(60) Provisional application No. 61/579,406, filed on Dec. 22, 2011.
(60) Provisional application No. 61/579,367, filed on Dec. 22, 2011.
(60) Provisional application No. 61/579,387, filed on Dec. 22, 2011.

(51) Int. Cl. G07F 17/34

(52) U.S. Cl. CPC G07F 17/34
USPC 463/20

(57) ABSTRACT

A game and gaming machine providing a plurality of arrays on an electronic display with each array having a plurality of game positions. During play of the game, the game positions can be randomly populated with game elements selected from a superset of elements. At least one element can be designated as a “scatter” element. Where a particular game position on one array is populated with a predetermined scatter element, a game element initially displayed in a congruent position on another array can be replaced with the scatter element. The arrays being manipulated into an overlapping configuration having more than two dimensions with the game positions forming linear groupings across the arrays. The game providing for evaluating the overlapping configuration of game elements for predetermined winning and non-winning outcomes.

### CROSS REFERENCE TO RELATED APPLICATION

This application claims the benefit of U.S. Provisional Patent Application Ser. No. 61/579,406 filed Dec. 22, 2011, U.S. Provisional Patent Application Ser. No. 61/579,367 filed Dec. 22, 2011 and U.S. Provisional Patent Application Ser. No. 61/579,387 filed Dec. 22, 2011. The entirety of these applications is hereby incorporated by reference as if fully set forth herein.

### FIELD

The invention pertains to an electronic game and gaming machine. More particularly, the invention pertains to such games and machines which provide replacing randomly selected game elements on a plurality of game arrays with a predetermined scatter element and transforming two-dimensional game arrays into a multidimensional game configuration.

### BACKGROUND

Electronic gaming machines for playing matching games are generally well known and have been relatively popular for a number of years. Typical video slot machines are an example of such gaming machines. As is customary with such machines, a display is usually provided which presents a single two dimensional array having a series of game positions. During play of such games, elements or symbols are variable at the particular game positions and will eventually stop with a set of symbols or elements in a particular fixed position relative one another. Typically, where a preselected collection of game elements span across a designated horizontal game line, a winning outcome is obtained.

As is generally known, the nature and format of such games have certain limitations with respect to the number and presentation of winning and non-winning outcomes. Specifically, the outcome of such games is determined by evaluating whether certain predetermined elements or symbols are selected and presented relative one another on a single array. For example, winning outcomes are usually produced when a set of identical symbols are presented in horizontal and/or vertical alignment across the individual game array. In light of such limitations, the number of possible outcomes and possible winning outcomes is largely limited by the random selection of game elements on a single game array. Such outcomes are further limited by the two-dimensional proportions (height and/or width) of the game array.

It has been recognized that due to such limitations, player interest in such games can drop over a period of time which may result in certain individual players deciding to cease playing the game and/or decline to play such machines again in the future. In settings where players are allowed to place wagers on the outcome of such games and such wagers generate revenue for the gaming establishment, it is generally undesirable to have a game that is not frequently played. Hence there are on-going needs to try to bring play variations to the audience of players in order to sustain their interest and desire to continue playing.

### BRIEF DESCRIPTION OF THE DRAWINGS

FIG. 1 illustrates a first sample configuration of a game as displayed on a gaming machine in accordance herewith.

FIG. 2 illustrates a second sample configuration of a game as displayed on a gaming machine in accordance herewith.

FIG. 3 illustrates a third sample configuration of a game as displayed on a gaming machine in accordance herewith.

FIG. 4 is a flowchart illustrating a method for playing a game in accordance with embodiments of the subject invention.

FIG. 5 is a block diagram of a gaming machine in accordance herewith.

### DETAILED DESCRIPTION

While this invention is susceptible of embodiment in many different forms, there are shown in the drawings and will be described herein in detail specific embodiments thereof with the understanding that the present disclosure is to be considered as an exemplification of the principles of the invention and is not intended to limit the invention to the specific embodiments illustrated. Specifically, although embodiments described herein are set forth for use in connection with a gaming unit of the type usually referred to as a “slot machine,” the subject embodiments are not limited to such and can be applied for use in connection with any game system, without limitation. Such systems can include, for example, coin-operated amusement devices, bar-top amusement devices, home gaming systems, video poker machines, or any other appropriate system.

Embodiments disclosed herein include a matching game suitable for playing on an electronic gaming machine featuring at least one electronic display. According to such embodiments, the display can present a plurality of two-dimensional game arrays to a player with each array having a plurality of game positions. During play of the game, the game positions of the arrays are randomly populated with a set of symbols or elements randomly selected from a superset of elements. At least one of the game elements in the superset of possible elements can be designated as a “scatter” element.

Where the random selection of game elements results in a scatter element being present at a particular game position on an array, the game will recognize the presence and location of the scatter element and any game elements which are in congruent positions on the other arrays can be replaced by the scatter element. Thus, according to embodiments disclosed herein, where a predetermined scatter element is initially present in a particular position on any one of the arrays after the initial randomization, the scatter element will be appear in that particular position on all of the arrays when the replacement process is complete.

Embodiments disclosed herein further provide for graphically manipulating the two-dimensional arrays on the display to form an overlapping multi-dimensional configuration having more than two dimensions. Such a multi-dimensional configuration can be formed by, for example, aligning or overlapping the two-dimensional arrays in series, one in front of the other, in a direction substantially perpendicular to their length. In such a configuration, congruent game positions of the individual arrays can be linearly aligned with one another to provide an additional third dimension (depth).

According to the rules of the game, certain configurations of game elements can be defined as predetermined winning outcomes. For example, such configurations can be a selection of identical elements at game positions in horizontal, vertical or diagonal alignment on a single array. In addition, the rules of the game can further define configurations formed by a selection of particular elements in linear alignment across the plurality of two-dimensional arrays to be winning outcomes. Thus, the multi-dimensional configuration provides for additional game outcomes over a two-dimensional game array and thus provides players with additional opportunities to obtain a winning outcome.

It will be recognized that the scatter element replacement process provides for a game played across a plurality of arrays such that an outcome on one game array can be influenced by configurations produced on the other game arrays and vice versa. Such embodiments can offer a more entertaining gaming experience by providing a game and gaming machine with a new and more visually appealing visual presentation in connection with a matching game.

Such embodiments can additionally provide for a game and gaming machine with increased opportunities for obtaining winning outcomes by producing substituting game elements from individual non-winning arrays with elements produced on one or more other arrays to provide a cumulative effect. It will further be recognized that by integrating such a new machine and method of play into familiar archetypes will allow players to easily understand the new gaming experience and provide an improved and sustained interest in playing the game. Such presentations heighten a player's enjoyment of the game and will induce a player to continue playing the game and/or select the game over other competing games in the future. Other benefits and advantages of the invention will become apparent in the following disclosure.

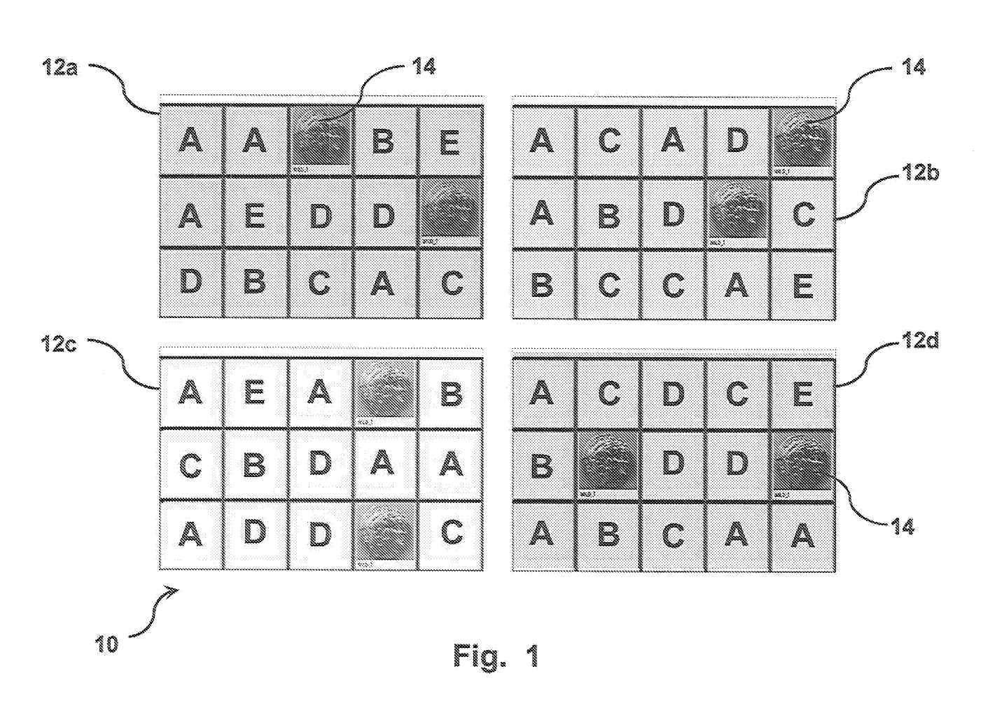

With reference now to the figures, FIG. 1-3 illustrate sample configurations of a game as presented on a gaming machine according to embodiments set forth herein. As shown in FIG. 1, the game can begin by presenting a plurality of two-dimensional game arrays 12a-12d to a player on a larger two dimensional electronic array or display 10. The arrays 12a-12d can have a plurality of game positions. For purposes of this description, the game positions of the individual arrays 12a-12d will be described as (X, Y) where X is the number of positions, starting from one, from the viewer's left in an individual row and Y is the number of positions, starting from one, from the top of the array in an individual column. Thus, as used herein, reference to “12d(1, 1)” would be referring to the uppermost and leftmost position in the lower right array, and “12a(5, 3)” would be the lowermost and rightmost position in the upper left array.

Although FIGS. 1-3 illustrate an embodiment featuring four two-dimensional game arrays 12a-12d each having a rectangular shape five positions wide and three positions high, embodiments of the subject invention are not limited to such. For instance, embodiments of the subject invention could feature more or less numbers of arrays, arrays having alternative shapes, and/or alternative numbers or arrangements of game positions without departing from the novel scope of the subject invention. In addition, although it is preferred that each of the arrays 12a-12d have substantially the same dimensions and corresponding game positions that are easily recognizable to a player, it is by no means required. If the game incorporates arrays have different shapes or dimensions, it is generally preferred that the game include a predefined and consistent method of mapping positions from a given array onto the other arrays to determine which positions are defined as congruent.

As illustrated in FIG. 1, in playing the game, the arrays 12a-12d can be populated with random symbols or game elements. For ease of reference, FIG. 1 shows non-scatter elements represented by letters of the alphabet (A through E) and scatter elements 14 represented by an image featuring a coin with a ‘W’ designation. Persons of ordinary skill in the art, however, will understand that the game elements (both non-scatter elements and scatter elements) can take any number of different forms without departing from the novel scope of the subject invention. For instance, game elements can be represented by any type of symbol, number, character, graphic, pattern, color, figure or any other image that can be visibly recognized or presented.

In addition, the same set of game elements can be used for all the arrays 12a-12d, or distinct sets of symbols can be used in connection with each individual array or predetermined subsets of arrays. It is preferred, however, that an image or symbol designated as a scatter element 14 be common to all arrays so that players will be able to easily recognize the scatter element when it is selected and be able to understand its significance in the game. It will be understood, however, that the game can feature one scatter element 14 or a plurality of different scatter elements without departing from the novel scope of the subject invention.

In playing the game, the randomly selected set of game elements can produce a configuration that is evaluated according to the rules of the game to identify whether any the game positions have been populated by predetermined scatter elements 14. For purposes of this description, it will be established that the rules of the game define a winning outcome as a configuration where a single row or column of game positions are populated with identical game elements. For exemplary purposes, it will further be established that the rules provide that the predetermined scatter element 14 is to be designed “WILD” which can be considered to be any game element in determining whether a winning outcome has been produced. Persons of ordinary skill in the art will understand, however, that the rules of the game can provide for alternate or additional types of winning outcomes, such as for example, a diagonal alignment of identical elements, identical elements in other particular game positions (e.g. in the four corners of an array), or an outcome with non-identical elements in a predetermined alignment or configuration (e.g. an array having different element in each game position).

According to such rules, it can be recognized that the random selection of game elements in FIG. 1 has produced only one winning line—that being the vertical alignment on array 12c of two scatter elements (considered to be “WILD”) at game positions (4,1) and (4,3) and one ‘A’ element at game position (4,2).

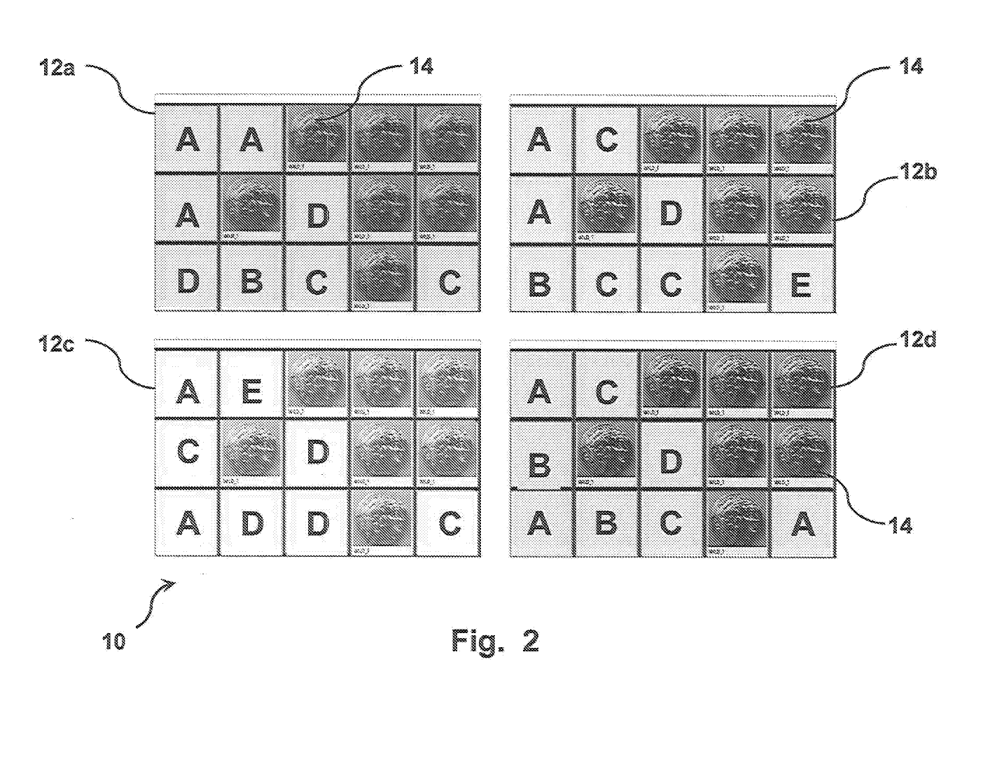

During play of the game, embodiments of the subject invention can provide for replacing game elements at particular game positions on one array with a predetermined scatter element 14, where the predetermined scatter element 14 has been randomly selected in a corresponding position on one of the other arrays 12a-12d. FIG. 2 illustrates a game display 10 presenting the exemplary configuration of game elements shown in FIG. 1 after such scatter replacement process. As show in FIG. 2, where a scatter element 14 was randomly selected in a particular position on one array, the scatter element 14 has been substituted for the initially selected game element in a congruent position on each of the other arrays 12a-12d. For instance, since game position (1,3) of array 12a was initially populated with a scatter element 14, the initially selected game elements at position (1,3) on the other arrays 12b-12d have been replaced by scatter elements 14.

As can be seen in FIG. 2, the scatter replacement process has produced additional winning outcomes that were not previously produced from the initial random selection of game elements. Specifically, according to the same rules described above where the scatter element 14 is designated WILD, each of the individual arrays 12a-12d has winning outcomes formed by the vertical alignment of three scatter elements 14 in the fourth column from the left. (4,1; 4,2 and 4,3) and the vertical alignment of two scatter elements 14 and a single game element in the fifth column from the left (5,1; 5,2 and 5,3).

It can further be observed in FIG. 2 that array 12a has an additional winning outcome formed by horizontal alignment at (1,1; 1,2; 1,3; 1,4 and 1,5), that array 12b has a new winning outcome formed by the vertical alignment at (2,1; 2,2 and 2,3), and that array 12c has a new winning outcome at (3,1; 3,2 and 3,3). In addition, where a winning outcome is defined as identical elements in the four corners of a single array, such a winning outcome has been formed in array 12d (see 1,1; 5,1; 1,3 and 5,3).

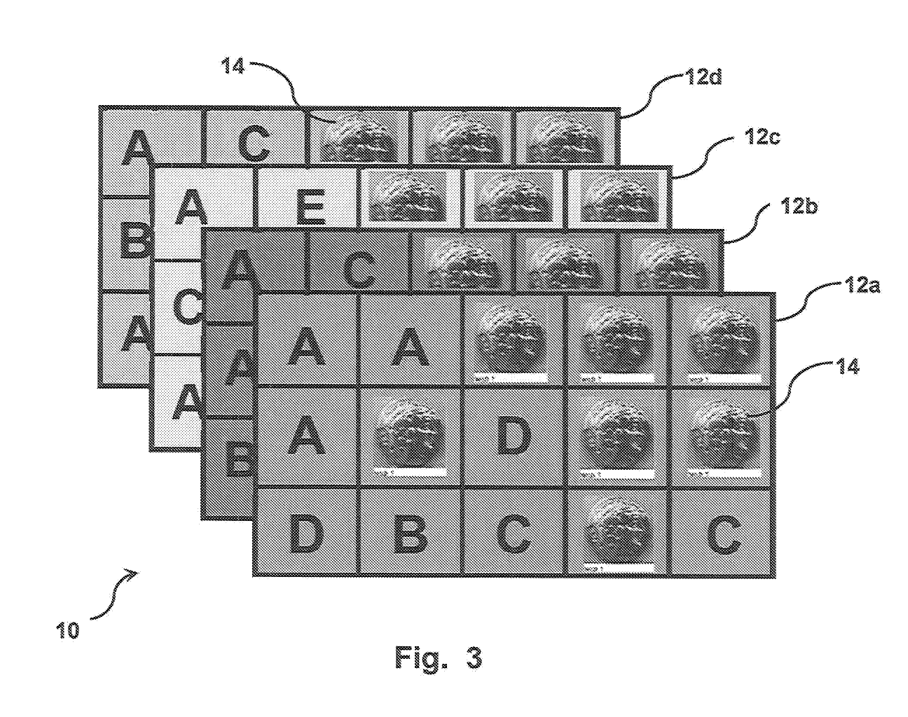

As illustrated in FIG. 3, embodiments presented herein can further provide for manipulating the plurality of two-dimensional arrays 12a-12d to form a multi-dimensional configuration 16. FIG. 3 illustrates a game display 10 presenting a sample multi-dimensional configuration 16 formed by the arrays 12a-12d illustrated in FIGS. 1-2. As shown in FIG. 3, such a multi-dimensional configuration 16 can be formed by moving the two-dimensional arrays 12a-12d into alignment in series such that they are positioned in succession one in front of the other as viewed by the player on the two-dimensional display 10. In this arrangement, congruent game positions of the arrays 12a-12d can be aligned with one another in a direction perpendicular to the length of the individual arrays 12a-12d. For example, position 12a(1,1) can be aligned with 12b(1, 1), 12c(1, 1) and 12d(1,1) to form a line across each of the arrays 12a-12d.

When a multi-dimensional configuration 16 has been formed, the game can further provide for evaluating the congruent game positions linearly across the two-dimensional arrays 12a-12d to determine whether a wining outcome has been produced. Thus, assuming the rules of the game for defining winning outcomes are the same as described above, it can be recognized in the sample embodiment shown in FIG. 3, that every horizontal linear line of congruent positions with a scatter element across the two-dimensional arrays (the “depth” lines) is a winning line. For instance, game positions 12a(3, 1), 12b(3, 1), 12c(3, 1) and 12d(3, 1) each have been randomly populated with a scatter element and thus can be defined as a winning outcome.

In addition, the multidimensional configuration 16 can produce additional winning outcomes across the arrays 12a-d that do not include a scatter element. For instance, in the embodiment shown in FIG. 3, an additional winning outcome could be defined as the horizontal alignment of game positions 12a(1, 1), 12b(1, 1), 12c(1, 1) and 12d(1, 1) because each have been randomly populated with an identical element (“A”). Moreover, the alignment of game positions 12a(3, 2), 12b(3, 2), 12c(3, 2) and 12d(3, 2) in FIG. 3 could also be defined as a winning outcome because each of the respective game positions contain an identical “D” game element.

It will be understood by persons of ordinary skill in the art that, depending on the rules of the game, the sample embodiment illustrated in FIG. 3 can have additional winning outcomes deriving from a line of diagonally tangent game positions through the multi-dimensional matrix 16. For instance, game positions aligned in a diagonal line comprising 12a(1, 1), 12b(1, 2) and 12c(1, 3) are populated with matching elements (“A”) and therefore this configuration could also be defined as a winning outcome. Persons of ordinary skill in the art will understand that numerous other linear (or non-linear) alignments through congruent game positions of the multi-dimensional configuration 16 can be defined as winning (or non-winning) outcomes, without departing from the novel scope of the subject invention.

It will be further understood that FIG. 3 is a static two dimensional representation of the multi-dimensional matrix 16 and thus some of the game elements on arrays 12a, 12b and 12c are visually obscured. Embodiments of the subject invention, however, can provide for a dynamic video display that, using techniques well-known to practitioners of the art, could rotate and/or selectively emphasize/deemphasize areas of the matrix 16 to show game positions on arrays 12a-c that are positioned behind the array 12d positioned in the foreground. For example, the arrays 12a-d can be displayed in a translucent manner which enables a player to see through the various arrays 12a-12d in order to observe whether a winning line has been produced in the additional dimension.

As can be seen, the number of possible permutations of elements in the three-dimensional matrix 16 as compared to the two-dimensional arrays 12a-12d increases dramatically. It will be recognized that this allows far more latitude in structuring the wager/payout rules of the game which in turn allows more flexibility in the wager payback ratio of the game, the volatility of the game, or both, without increasing the number of elements used. This makes the game easier to follow than it would be if the payback ratio/volatility were adjusted by increasing the number of elements used, which is the only way to do so (absent manipulation of outcomes) when using a two-dimensional array of fixed size.

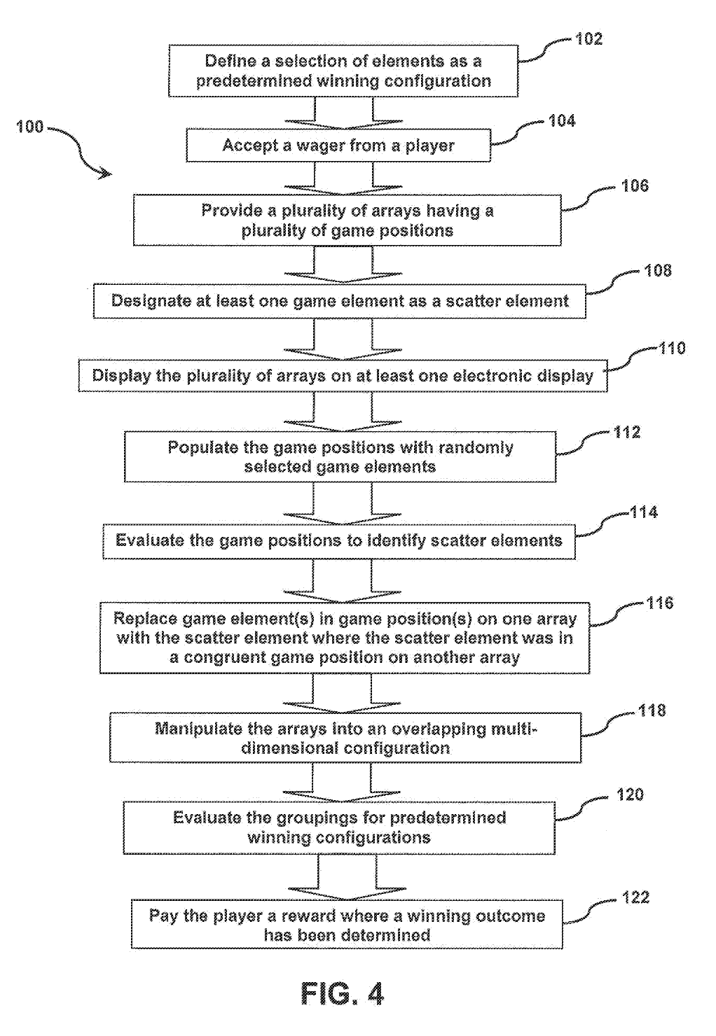

FIG. 4. illustrates a sample method 100 in which a game is carried out according to embodiments disclosed herein. For instance, when a player initiates play of the game, the game can provide and display a plurality of two-dimensional arrays on the electronic display 106, 110, with each array having a plurality of game positions. The game can start with the arrays in any particular arrangement relative one another. The game further provides for populating the positions with randomly selected game elements 112 and evaluating the configuration to identify game positions having a predetermined scatter element 114. Where a scatter element has been identified in a particular game position, the game can substitute the scatter element for the initially selected game element in corresponding game positions on the other arrays 116.

The game can further provide for manipulating the arrays into the overlapping multi-dimensional configuration 118 such that congruent game positions of the individual arrays form linear groupings in a third (“depth”) dimension. Persons of ordinary skill in the art will understand that the random population of game elements onto the arrays 112, the scatter replacement process 116 and the manipulation of arrays into the multidimensional configuration 118 can take place in any order with any one of these actions taking place before or after the others, or not at all.

Persons of ordinary skill in the art will understand that the game provides for defining a selection of elements as a predetermined winning configuration according to the specific rules of the game 102. As described above, the rules of the game can provide for a number of possible combinations, arrangements or configurations as winning or non-winning outcomes. Where the game determines that a predetermined winning configuration exists, the configuration can be recognized as a winning outcome 120 and the player can be alerted to this outcome. In settings where players are permitted to wager on the outcome of the game, the game can further accept wagers from the player 104 and distribute rewards or credits to a player that has wagered on a game that has produced a winning outcome 122.

Embodiments of the subject invention can further provide for the scatter replacement process 116 or the manipulation of arrays into the multi-dimensional configuration 118 can be to be initiated by some secondary event that can be random or player-initiated. For instance, according to embodiments disclosed herein, a player through skill in play or random chance can designate either a particular game element, or a particular game position, as a scatter element 14. At the time of such designation, a preselected rule would govern the scatter replacement process 116. If the player designates a game position before the initial randomization, whatever game element appears in that position can become a scatter element 14 for purposes of final evaluation. If the player selects a particular game element as the scatter element 14, that particular game element can function as the scatter element 14 for that game.

Additionally, a scatter element 14 can be randomly selected from a superset of game elements in some other area of the display 10 or by the outcome of some other type of game or process. Persons having ordinary skill in the art will understand that variations with respect to selecting a scatter element and reproducing it onto multiple other arrays can take alternate forms without departing from the novel scope of the subject invention.

In addition, the game can further allow a player to preselect the order or formation in which the arrays 12a-12d are to be arranged in the multi-dimensional configuration 16. Such pre-selection can be accomplished via intentional designation or through the outcome of some particular side-game or event based on random chance or player skill.

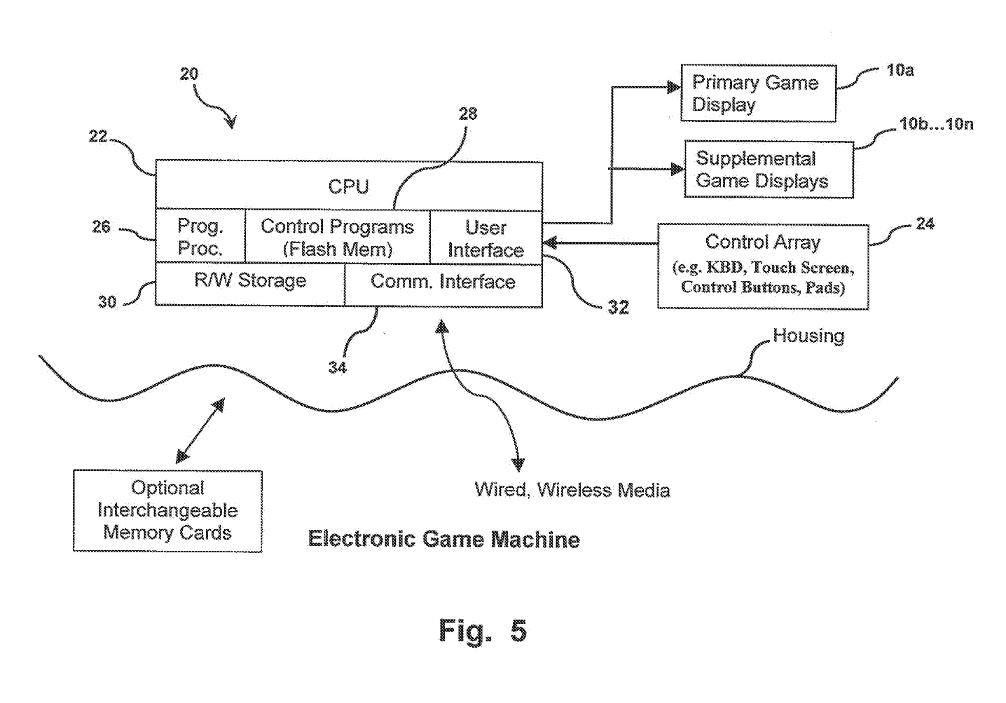

FIG. 5 illustrates additional components of the gaming machine 20 according to embodiments of the subject invention. The gaming machine 20 can include a computer 22, at least one electronic game display 10 and control array 24. The computer 22 can have a programmable processor 26, memory 28, a storage unit 30 and user interface 32. In addition, the memory 28 can include a main memory containing dynamic information processed by the programmable processor 26 during operation, and/or a static memory which contains fixed information, such as an operating system, game programs, and configuration information necessary for the processor 26 to consistently process input from the player through the control array 24.

Embodiments of the subject invention further provide that the control array 24 can be implemented as one or more of a keyboard, mechanical lever, a touch-screen, buttons or pads and/or any other means for control or desired combination of controls able to accept input from a player and produce output to the game display 10 in response to a player's input. Additionally, the gaming machine 20 can incorporate one game display 10, or multiple game displays 10a,b . . . n without departing from the novel scope of the invention. Such displays 10 can be a LCD, LED, CRT display device or any other type of electronic display known in the art.

The gaming machine 20 can additionally include communication interface 34 to communicate information regarding the game to another electronic device, such as for example a database, server, computer or handheld device. Such communications can enable players on different machines to play the game together or to compete against one another. It can further enable designers, technicians and operators to assess, monitor and record analytical information about the game, the players and/or the machine. This can result in easier and faster repair, maintenance or updating of the game or machine, and can further contribute to a better understanding of the way in which it is played for purposes of improving future game play. Such communication can be processed via a remote or local area network and can be wired or wireless.

While various processes for evaluating the outcome of a game come within the spirit and scope of the present invention, in one exemplary embodiment the computer 22 can contain within its static memory 28 either an algorithm for examining a particular outcome against a fixed set of rules to determine whether it is a winning outcome. Alternatively, a list or table of all possible winning outcomes can be provided and the particular outcome of a game can be compared to the stated winning outcome on the list or table. The computer 22 can additionally determine the outcome of a particular game using the rules stored in the static memory 28, and further recognize the outcome as a particular individual outcome.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

Moreover, Applicant hereby expressly incorporates by reference all subject matter disclosed in co-pending patent applications entitled “Method and Apparatus for Playing a Game with Multidimensional Game Cards” which is identified by attorney docket number 9003/114935-UTI and “Method and Apparatus for Playing a Game with Scatter Replacement Feature” which is identified by attorney docket number 9003/114936-UTI, including any subject matter disclosed in any provisional, continuation, division, reissue, or extension of any such application.

Further, logic flows depicted in the figures do not require the particular order shown, or sequential order, to achieve desirable results. Other steps may be provided, or steps may be eliminated, from the described flows, and other components may be add to, or removed from the described embodiments.

What is claimed is:

1. A method for playing a game comprising:
providing a plurality of two-dimensional arrays each having a plurality of game positions for presenting game elements;
displaying the plurality of arrays on at least one electronic display;
designating at least one game element as a scatter element;
populating the game positions with randomly selected elements;
defining a selection of game elements as a predetermined winning configuration;
replacing a game element populated in a game position on one array with the scatter element where the scatter element was populated in a congruent game position on another different array;
manipulating the arrays into an overlapping configuration having more than two dimensions where the game positions form linear groupings across the arrays; and
evaluating the selection of game elements to identify predetermined winning configurations.

2. The method of claim 1 further comprising accepting a wager from a player.

3. The method of claim 2 further comprising rewarding the player where a winning configuration has been identified.

4. The method of claim 1 where each of the plurality of arrays have game positions in substantially horizontal and vertical alignment.

5. The method of claim 4 where a predetermined winning configuration is defined by a selection of identical elements across a horizontal line of game positions on a single array.

6. The method of claim 4 where a predetermined winning configuration is defined by a selection of identical elements along a vertical column of game positions on a single array.

7. The method of claim 4 where a predetermined winning configuration is defined by a selection of identical elements aligned linearly across a plurality of arrays of the overlapping configuration.

8. The method of claim 1 where the arrays are substantially rectangular in shape.

9. The method of claim 1 where the arrays have substantially identical dimensions.

10. The method of claim 1 further comprising mapping positions from one array onto a second different array.

11. The method of claim 1 where the designated scatter element is defined as WILD and according to the rules of the game is evaluated as a match for any other game element in evaluating the selection of game elements to identify predetermined winning configurations.

12. The method of claim 1 where the game elements presented on each of the plurality of arrays are selected from the same superset of game elements.

13. A gaming machine for playing a game, the machine comprising:
at least one electronic display presenting a plurality of two-dimensional arrays, each array having a plurality of game positions; and
circuitry coupled to the display, wherein during play of the game, the game positions are populated with game elements randomly selected from a superset of game elements, one game element being designated as a scatter element, a game element populated in a game position on one array being replaced with the scatter element where the scatter element was populated in a congruent game position on another different array, the arrays being manipulated into an overlapping configuration having more than two dimensions, the game positions forming linear groupings across the arrays.

14. The gaming machine of claim 13 where the arrays are substantially rectangular in shape with game positions in substantially horizontal and vertical alignment.

15. The gaming machine of claim 13 where the arrays have substantially identical dimensions.

16. The gaming machine of claim 13 where during play of the game predetermined winning and non-winning configurations of game elements are formed relative their arrangement at specific game positions.

17. The gaming machine of claim 16 where a predetermined winning configuration is formed by a selection of identical game elements across a horizontal line of game positions on a single array.

18. The gaming machine of claim 16 where a predetermined winning configuration is formed by a selection of identical game elements along a vertical column of game positions on a single array.

19. The gaming machine of claim 16 where a predetermined winning configuration is formed by a selection of identical game elements in linear alignment across a plurality of arrays of the overlapping configuration.

20. A gaming machine for playing a game, the machine comprising:
a computer;
a control array coupled to computer via a user interface;
at least one electronic display coupled to the computer, the at least one display electronically presenting a plurality of arrays having a plurality of game positions where during play of the game the game positions are populated with elements randomly selected from a superset of elements, one game element being designated as a scatter element, a game element populated in a game position on one array being replaced with the scatter element where the scatter element was populated in a congruent game position on another different array, the arrays being manipulated into an overlapping configuration having more than two dimensions, the game positions forming linear groupings across the arrays.

21. The gaming machine of claim 20 where the control array comprises a keyboard, mechanical lever, button or touch-screen.

22. The gaming machine of claim 20 where the computer includes a programmable processor, memory and a storage unit.

23. The gaming machine of claim 20 further comprising a communication interface coupled to the computer, the communication interface suitable for communicating information with other electronic devices via electronic signals.

24. The gaming machine of claim 23 where the communication interface communicates via wired or wireless signals.

25. The gaming machine of claim 20 where the electronic display is a LCD, LED or CRT display device.

26. A game comprising:
electronic circuitry providing a plurality of arrays each having a plurality of game positions for presenting game elements;
an electronic display coupled to the circuitry, the display presenting the plurality of arrays; and
the circuitry populating the game positions with randomly selected game elements selected from a superset of elements, defining a selection of game elements as a predetermined winning configuration, designating at least one game element as a scatter element, replacing a game element populated in a game position on one array with the scatter element where the scatter element was populated in a congruent game position on another different array, manipulating the arrays into an overlapping configuration having more than two dimensions, the game positions forming linear groupings across the arrays, and evaluating the selection of game elements to identify predetermined winning configurations.
